(19) United States
(12) Patent Application Publication
(10) Pub. No.: US 2003/0018507 A1
(43) Pub. Date: Jan. 23, 2003

(54) Construction scheduling system

(76) Inventor: Ed Flanagan, Winter Park, FL (US)

Correspondence Address: ALLEN, DYER, DOPPELT, MILBRATH & GILCHRIST, P.A., Suite 1401, 255 South Orange Avenue, P O Box 3791, Orlando, FL, 32801, US

(21) Appl. No.: 10/097,806

(22) Filed: Mar. 13, 2002

Related U.S. Application Data
(60) Provisional application No. 60/275,318, filed on Mar. 13, 2001.

(51) Int. Cl. G06F 17/60

(52) U.S. Cl. 705/8

(57) ABSTRACT

A system and process for scheduling a plurality of simultaneous construction projects includes at least one server computer connected to a computer network, software capable of scheduling multiple events among a plurality of construction projects, said software controlling said at least one server computer, and a plurality of field communication devices each device of said plurality having a display and being capable of wirelessly connecting through the computer network for interactively communicating with said at least one server computer through a security controlled access including a unique identifier corresponding to each individual field communication device. Field communication devices according to the invention preferably include geographic positioning capability to allow tracking of the device.

### RELATED APPLICATION

This application claims priority from co-pending provisional application Serial No. 60/275,318 which was filed on Mar. 13, 2001, and which is incorporated herein by reference in its entirety.

### FIELD OF THE INVENTION

The present invention relates to the field of management of construction projects, more specifically to a system for scheduling a construction project, and particularly for scheduling large construction projects for single family homes where the builder must simultaneously keep track of multiple events at multiple construction sites.

### BACKGROUND OF THE INVENTION

Large scale construction projects, particularly those involving many building sites where construction is proceeding simultaneously, are very difficult to manage efficiently. Such large scale projects involve, for example, the construction of residential developments and planned communities. In these projects, there usually are many building sites at different stages of construction. Many different subcontractors are involved in providing services, and the work by the subcontractors must be appropriately coordinated, so that the building steps are accomplished in the required order. Additionally, many different building materials must be ordered and delivered on time to the construction sites. For efficiency, and for cost control, building materials must not be ordered or delivered too early, or too late. Orders placed too early, and too early deliveries cause increased costs in that funds are tied up for unnecessarily long periods of time. Also, materials delivered too early to a construction site are exposed to the elements and to pilfering for a time longer than necessary. Conversely, orders placed too late may result in materials not delivered on time, causing construction sites to possibly remain idle while awaiting back orders of materials. Such delays also result in added financial costs to the builder.

### SUMMARY OF THE INVENTION

With the foregoing in mind, the present invention advantageously provides a computerized system for large project homebuilders that is designed to provide detailed construction schedules directly to the builder's suppliers and subcontractors, and management reports for the builder's personnel via a password protected internet site.

The system relies on field supervisors supplying data related to the status of each building project. All data will be input by the builder or his designated administrator. The data are collected and entered into the system preferably by a wireless field communication device, and include recording the completion of scheduled tasks. The field communication device may be a computer, or more preferably may be any type of wireless communication device capable of connecting to a computer network, and particularly a global computer network such as the internet. Most preferably, however, information and data from the field, i.e. sites of construction projects, are entered into the system through a hand-held device such as a cellular telephone, a pager, or a personal digital assistant (also known as a PDA or palmtop computer). All these devices may be connected to the global computer network by on-line communications, or by wireless service, thus being able to easily communicate with the system directly from a construction job site.

Information entered through the field communication device and is then transmitted by the computer network to a server computer for storing and processing. The server computer's interactive software program calculates and updates all schedule data for each construction site. The updated schedule is available to the contractor, and to suppliers and subcontractors through internet dynamic web sites. In addition, the system's software provides management reports either periodically or on demand to the responsible builder, to his field supervisor(s), and to trades contractors, as desired. These reports will track all scheduling aspects of each construction site, including performance variances in material deliveries by suppliers, scheduled completion projections, and payment approvals for the builder's use in paying for supplies and services.

The system and software are designed to be easily modified to adapt to differences in builder operations. A typical builder user of the system would be a local homebuilder or the local division of a national homebuilding company with simultaneous construction projects proceeding in multiple subdivisions in a generally contiguous region such as a metropolitan area. The system is designed to provide for multiple trades for the same tasks, as necessary. Data input screens are provided to input subdivision information, model home types, and trades. Level of access to the web site is defined and limited by a hierarchy of builder, field supervisor, and trades, including for example, suppliers and subcontractors.

The system will help reduce the time required to construct a standard model home unit by providing instant scheduling information with a protected web page for each trade, showing the start and finish dates for all housing units under contract to that trade, preferably sorted by completion date. Additionally, the system will generate management reports that are available both as automatic reminders, and on demand for the builder's personnel to assist their management roles. These management reports preferably include a weekly variance report that lists each specific situation where a trade's completion date varies from the current schedule, and a projected completion report that provides a current estimated completion date for each housing unit. Reports may be sorted by any desired field of information, including by completion date and/or by subdivision.

The construction management system of the present invention will help reduce the expense of loan interest for housing units under construction, reduce the number of units under simultaneous construction, reduce the overhead expense, reduce the number of personnel required. Alternatively, the construction management system will permit supervisors to increase the number of home construction sites under their control, while maintaining the same number of employees. The system will, additionally, help increase the number of homes delivered to customers on schedule.

The construction management system is also referred to as a vertical portal management system, as it provides its customer builders with selective access to system screens. The system includes several features and processes. The system's standard functionality will be available to a builder upon activation of the builder's account in the system. New builders may be added to the system without having to provide additional programming. The system allows each new builder to provide a logo and name for their specific pages.

The construction management system administrator can maintain the components of the system through an internet interface. For example, builder-specific logos are added by the system administrator through this interface. The system administrator adds new builders, manages billing, maintains passwords to the system, and disconnects builder accounts.

The system additionally serves as an advertising platform wherein banner ads for various goods and services may be displayed. The system administrator will, through the system's software, track sales of ad spaces, and commissions for a sales force. Security of the system is enhanced by providing that each builder has independent password controlled access from every other builder. Security may be enhanced by providing that each individual field communication device includes its own specific identifier recognized by the system. Additionally, the system is preferably configured so as to not be usable for surfing the internet.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a typical information flow in the system for a subdivision having lots under construction, according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

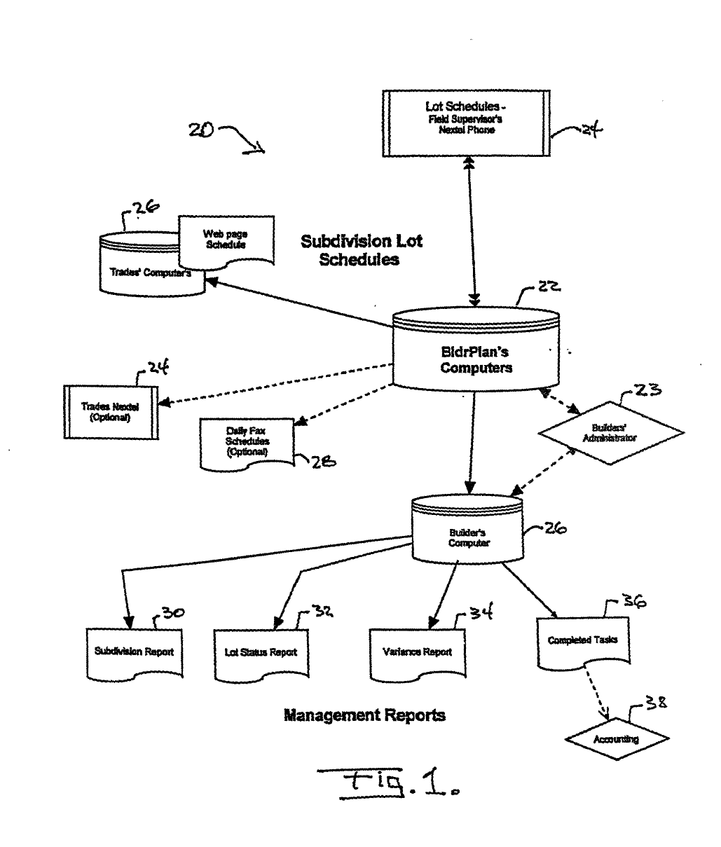

FIG. 1 and Tables 1-7 show various aspects of a system for scheduling a plurality of simultaneous construction projects. As shown in FIG. 1, the system 20 of the present invention comprises at least one server computer 20 connected to a computer network, software controlling the server computer and capable of scheduling multiple events among a plurality of construction projects, and a plurality of field communication devices 24 each device of said plurality having a display and being capable of wirelessly connecting through the computer network for interactively communicating with the server computer 22 through security controlled access thereto. Typical security controlled access includes password protection, however, in one preferred embodiment of the invention security controlled access includes a unique identifier corresponding to each individual field communication device 24. In yet another preferred embodiment each field communication device 24 includes geographic positioning capability so as to communicate its position to the server computer 22.

The invention includes a plurality of field communication devices 24 for interacting with the scheduling system 20. Particularly useful devices for field supervisors and others at the various construction sites are field communication devices 24, which in the invention are intended to comprise cellular telephones, personal digital assistants (also known as PDAs, and as palmtop computers), electronic pagers, and combinations thereof. Most preferably, cellular telephones for use in the inventive system disclosed herein include those capable of communicating by radio transmission in addition to standard cellular telephone communication, for example the well known devices marketed by Nextel.

Referring again to FIG. 1, by way of explanation, the function of the illustrated example of the invention is as follows. Information and data may be entered into the system server computer 22 by the builder's administrator 23 and by the builder's field supervisors 24. Such data entry may be accomplished either from a personal computer or from the field, more typically, by a hand-held wireless device such as a PDA or a cellular telephone. The server computer 22 communicates with computers of the various trades subcontractors and can provide the subcontractors with a schedule of their tasks. In addition, the server computer 22 may communicate information to a tradesman's cellular telephone, such as a Nextel phone, or may send a schedule to the trade subcontractor via a daily fax transmission 28. The system server computer 22 may also communicate with the builder's computer 26 to provide information regarding various subdivisions 30 in progress, lot status reports 32, variance reports 34, and a log of completed tasks 36, for example. The skilled will know that other information may also be available from the system server computer 22, as desired by the client builder. A log of completed tasks is particularly useful as a component of an accounting system 38, to ascertain that only completed work receives payment.

Those skilled in the art will recognize that the system of the invention includes a computer network comprising a global computer network, and particularly the internet or world-wide web. In addition to the field communication devices noted above, the system 20 may further comprise at least one client computer 26 interactively communicating with the server computer 22. The system 20 may also include at least one fax machine connected to receive a fax transmission from the server computer 22, a convenient method for disseminating status reports generated by the system, particularly when the fax transmission is effected through the computer network.

Process aspects of the invention include scheduling a plurality of construction projects. The process comprises creating a plurality of construction schedules in a database stored in a server computer, each construction schedule of the plurality corresponding to an individual construction project. Accessing the database is accomplished by security controlled communication through a computer network, which is preferably a global computer network such as the internet. A typical entry screen display is shown in Table 1, which shows a main menu screen display for the present system. The process also includes updating information for individual construction schedule records in the database, an activity which may be performed by any authorized system user but is generally performed by a builder's field supervisor as job tasks, materials deliveries, or other scheduled events are completed. Payments for such completed events may also be approved and tracked through the system. The method further includes generating a status report for a predetermined construction schedule by processing information in the database to thereby monitor progress of the corresponding construction project. Tables 1-3 show typical screen displays for accessing information through the system 20. For example, Table 2

TABLE 1

| Task List | | | | | Paid | |
|---|---|---|---|---|---|---|
| Tasks Before | Task# | Description | Duration | Activity | Item | Tasks After |

Create New Task

| | | | | | | |
|---|---|---|---|---|---|---|
| 101-Building Permit | 100 | Building Permit | 15 | | [symbol] | 102-Stake Out |
| Posting | 101 | Building Permit Posting | 1 | 5001 | [symbol] | 100-Building Permit |
| 100-Building Permit | 102 | Stake Out | 1 | | [symbol] | 104-Build Pad |
| 102-Stake Out | 104 | Build Pad | 1 | | [symbol] | 106-Dig Footer |
| 104-Build Pad | 106 | Dig Footer | 1 | | [symbol] | 108-Inspect Footer |
| 106-Dig Footer | 108 | Inspect Footer | 1 | | [symbol] | 110-Pour Footer |
| 108-Inspect Footer | 110 | Pour Footer | 1 | | [symbol] | 112-Stemwall Material |
| 110-Pour Footer | 112 | Stemwall Material | 1 | | [symbol] | 114-Build Stemwall |
| | | | | | | 116-Survey |
| 112-Stemwall Material | 114 | Build Stemwall | 1 | | [symbol] | Foundation |
| | | | | | | 118-Backfill Stemwall |
| 114-Build Stemwall | 116 | Survey Foundation | 10 | | [symbol] | 120-Rough Grade |
| | | | | | | 120-Rough Grade |
| 114-Build Stemwall | 118 | Backfill Stemwall | 1 | | [symbol] | 122-Underground |
| | | | | | | Plumbing |
| 116-Survey | 120 | Rough Grade | 1 | | [symbol] | 124-Sewer Connect |
| Foundation | | | | | | 126-Underground A/C |
| 118-Backfill Stemwall | | | | | | 128-Underground |
| | | | | | | Electric |
| 118-Backfill Stemwall | 122 | Underground Plumbing | 2 | | [symbol] | 130-Underground |
| | | | | | | Inspection |
| | | | | | | 132-Sewer Inspection |
| | | | | | | 134-Soil Treatment |
| | | | | | | 136-Density Test |
| | | | | | | 138-Prep |
| 122-Underground | 124 | Sewer Connect | 1 | | [symbol] | Slab/Columns |
| Plumbing | | | | | | |
| 122-Underground | 126 | Underground A/C | 1 | | [symbol] | |
| Plumbing | | | | | | |

TABLE 2

| Current Trade Companies | | | | | | |
|---|---|---|---|---|---|---|
| Trade Company | Vendor ID | Contact | Phone | Details | Skills | Delete |

Add Trade

| | | | | | | |
|---|---|---|---|---|---|---|
| 31W Insulation | 345 | Edward Kunningham | (407)123.4567 | [symbol] | [symbol] | [symbol] |
| Adam's Lumber | sdd | Adams Lumber | (407)456.7891 | [symbol] | [symbol] | [symbol] |
| Affordable Plumbing | a1204 | Nick Knicky | (407)123.7894 | [symbol] | [symbol] | [symbol] |
| American Insulation | a1245 | Scratch Jones | (407)123.7412 | [symbol] | [symbol] | [symbol] |
| Apollo marble | a7856 | Abe Stone | (352)159.7532 | [symbol] | [symbol] | [symbol] |
| Asbury Trim | 375-456 | John Ashbury | | [symbol] | [symbol] | [symbol] |
| Bill's landscaping | | | | [symbol] | [symbol] | [symbol] |
| CCL Survey | | | | [symbol] | [symbol] | [symbol] |
| CDM Enterprises | | | | [symbol] | [symbol] | [symbol] |
| Central Supply Company | C425 | Jeff Depew | (407)299.1841 | [symbol] | [symbol] | [symbol] |
| Collis Roofing | | | | [symbol] | [symbol] | [symbol] |
| Conniglio Grading | | | | [symbol] | [symbol] | [symbol] |
| Contractor yard | | | | [symbol] | [symbol] | [symbol] |
| CRT Framers | | | | [symbol] | [symbol] | [symbol] |
| Curry Grading | | | | [symbol] | [symbol] | [symbol] |
| D & E Elect | | | | [symbol] | [symbol] | [symbol] |
| D & S Tilers | | | | [symbol] | [symbol] | [symbol] |
| Dan Morgan Concrete | | | | [symbol] | [symbol] | [symbol] |
| Decor Carpet | | | | [symbol] | [symbol] | [symbol] |
| DelAire HVAC | | | | [symbol] | [symbol] | [symbol] |
| Demo Homes Title Co | dhtc | Jane Jones | (407)564.7895 | [symbol] | [symbol] | [symbol] |
| Demo-Jones | dtj | Tom Jones | (407)569.7894 | [symbol] | [symbol] | [symbol] |
| DeWitt Concrete | | | | [symbol] | [symbol] | [symbol] |

TABLE 3

| | | | | |
|---|---|---|---|---|
| Builder Administrators | | | | |
| Name | Login ID | Password | Edit | Delete |

Add Administrator User

| Admin Manager | admin | winner | [symbol] | [symbol] |
|---|---|---|---|---|
| Builder Managers | | | | |
| Name | Login ID | Password | Edit | Delete |

Add Manager User

| Mister Manager | | 9874 | 11234 | [symbol] | [symbol] |
|---|---|---|---|---|---|
| Ned North | | 1245hot | stuff | [symbol] | [symbol] |
| Scott South | | South | Division | [symbol] | [symbol] |
| Subdivision Supervisors | | | | | |
| Subdivision | name | Login ID | Password | Edit | Delete |
| Country Lake | Joe Smith | cyl | 1234 | [symbol] | [symbol] |
| Nouvou Ridge | Jim Thompson | got | rocks | [symbol] | [symbol] |
| Raintree Village | Tom Jones | 123 | 4567 | [symbol] | [symbol] |
| The Landings | William Williams | Landings | kig | [symbol] | [symbol] |
| Whisperin Pines | Jim Smith | hank | test | [symbol] | [symbol] |
| Trade Company Users | | | | | |
| Trade Name | Name | Login ID | Password | Edit | Delete |
| 31W Insulation | Edward Kunningham | sa | sa | [symbol] | [symbol] |
| Adam's Lumber | Adams Lumber | adams | lumber | [symbol] | [symbol] |
| Affordable Plumbing | Nick Knicky | aff | plumb | [symbol] | [symbol] |
| American Insulation | Scratch Jones | american | Insulation | [symbol] | [symbol] |
| Apollo marble | Abe Stone | apollo | marble | [symbol] | [symbol] |
| Asbury Trim | John Ashbury | asbury | TRIM | [symbol] | [symbol] |
| Bill's landscaping | | bill | landscape | [symbol] | [symbol] |

TABLE 4
Trade Companies Report
Subdivision: Raintree Village

| Trade | Vendor ID | Contact | Phone | Email |
|---|---|---|---|---|
| 31W Insulation | 345 | Edward Kunningham | (407)123.4567 | 31winsulation@aol.com |
| Affordable Plumbing | a1204 | Nick Knicky | (407)123.7894 | downhill@aol.com |
| American Insulation | a1245 | Scratch Jones | (407)123.7412 | ichy@who.com |
| Apollo marble | a7856 | Abe Stone | (352)159.7532 | stone@nyt.net |
| Bill's landscaping | | | | |
| CCL Survey | | | | |
| CDM Enterprises | | | | |
| Central Supply Company | C425 | Jeff Depew | (407)299.1841 | depew@centralsupply.net |
| Collis Roofing | | | | |
| Contractor yard | | | | |
| D & E Elect | | | | |
| D & S Tilers | | | | |
| Decor Carpet | | | | |
| Demo Homes Title Co | dhtc | Jane Jones | (407)564.7895 | dhtc@msn.com |
| Demo Jones | dtj | Tom Jones | (407)569.7894 | tjones@demo.homes |
| DeWitt Concrete | | | | |
| DQM | | | | |
| East Coast Lumber | | | | |
| Empire Fence | | | | |
| FL Power | FLP | | | |
| Florida Pools | | | | |
| General Elect | | | (407)325.3456 | |
| Hermes Stone Co | herme | Sam Hermes | (407)265.8974 | dorothyhermes@sym.com |
| Hudson Pest Control | | | | |
| Jana Lucas | | | | |
| Lucas Const | | | | |
| Maddox Aluminum | | | | |
| Mail Box Installer | 3456 | Ed Flanagan | | |
| Masonry Supply Co | msc | Ham Hammocks | (407)235.7894 | hammy@dsl2.com |
| One Stop HVAC | | | | |
| Orange County | occ | | (407)579.4797 | |
| Orange County | OCBD | | (407)579.4797 | ocbd@msl.org |
| Building Dept | | | | |
| Orlando Munl Company | 458-789 | Bill Toms | (407)456.9874 | omc@aol.com |
| Raphael Garcia | | | | |
| RCS | | | | |
| Sam Wilson Masonry | 345-456 | Jim Wilson | (312)987.6547 | blockhead@aol.com |
| Smyth Engineers | smyth | Tom Jones | (407)236.4875 | smytheng@aol.com |
| Sonshine Drywall | | | | |
| Spurlock Painting | | | | |
| Stairbuilders Inc. | stair | Swede Swensen | (312)987.4561 | sweedes@sty.com |
| Top Notch Cleaning | | | | |

TABLE 5
Lot Status Report
Lot: 108

| Lot | | | | |
|---|---|---|---|---|
| Number | Task | Start Date | End Date | Duration |
| 108 | Lintel Inspection | Nov. 30, 2001 | Nov. 30, 2001 | 1 |
| 108 | Underground A/C | Jan. 9, 2002 | Jan. 8, 2002 | 0 |
| 108 | Pour Lintel | Mar. 7, 2002 | Mar. 7, 2002 | 1 |
| 108 | Truss Materials | Mar. 8, 2002 | Mar. 8, 2002 | 1 |
| 108 | Frame Materials | Mar. 8, 2002 | Mar. 8, 2002 | 1 |
| 108 | Set | Mar. 11, 2002 | Mar. 15, 2002 | 5 |
| | Trusses/Sheathing | | | |
| 108 | Wall/Roof | Mar. 18, 2002 | Mar. 18, 2002 | 1 |
| | Inspection | | | |
| 108 | Exterior Glass | Mar. 18, 2002 | Mar. 18, 2002 | 1 |
| | Blocks | | | |
| 108 | Rough Stairs | Mar. 18, 2002 | Mar. 18, 2002 | 1 |
| 108 | SGD/Windows | Mar. 18, 2002 | Mar. 20, 2002 | 3 |
| 108 | Interior Partitions | Mar. 18, 2002 | Mar. 20, 2002 | 3 |
| 108 | Water Services | Mar. 18, 2002 | Mar. 18, 2002 | 1 |
| 108 | Construction | Mar. 21, 2002 | Mar. 21, 2002 | 1 |
| | Clean#1 | | | |
| 108 | Exterior Doors | Mar. 21, 2002 | Mar. 21, 2002 | 1 |
| | Set | | | |
| 108 | Preface Fireplace | Mar. 21, 2002 | Mar. 21, 2002 | 1 |
| 108 | Marble Tub | Mar. 21, 2002 | Mar. 21, 2002 | 1 |
| 108 | Rough Plumbing | Mar. 21, 2002 | Mar. 25, 2002 | 5 |
| 108 | Rough A/C | Mar. 22, 2002 | Mar. 25, 2002 | 4 |
| 108 | Rough Electric | Mar. 26, 2002 | Apr. 1, 2002 | 7 |
| 108 | A/C Inspections | Mar. 26, 2002 | Mar. 26, 2002 | 1 |
| 108 | Plumbing | Mar. 26, 2002 | Mar. 26, 2002 | 1 |
| | Inspections | | | |
| 108 | Electrical | Apr. 2, 2002 | Apr. 2, 2002 | 1 |
| | Inspections | | | |
| 108 | PreDrywall | Apr. 2, 2002 | Apr. 2, 2002 | 1 |
| | Orientation | | | |
| 108 | Roof - Materials | Apr. 2, 2002 | Apr. 2, 2002 | 1 |
| 108 | Frame Inspections | Apr. 3, 2002 | Apr. 3, 2002 | 1 |
| 108 | Roof - Installation | Apr. 3, 2002 | Apr. 8, 2002 | 6 |
| 108 | Wire Lath | Apr. 4, 2002 | Apr. 4, 2002 | 1 |
| 108 | Insulation | Apr. 4, 2002 | Apr. 4, 2002 | 1 |
| 108 | Drywall - | Apr. 4, 2002 | Apr. 4, 2002 | 1 |
| | Material | | | |
| 108 | Stucco | Apr. 5, 2002 | Apr. 10, 2002 | 6 |
| 108 | Insulation | Apr. 5, 2002 | Apr. 5, 2002 | 1 |
| | Inspection | | | |
| 108 | Drywall - | Apr. 8, 2002 | Apr. 16, 2002 | 9 |
| | Hang & Finish | | | |
| 108 | Stone Elevation | Apr. 11, 2002 | Apr. 15, 2002 | 5 |
| 108 | Exterior Painting | Apr. 11, 2002 | Apr. 12, 2002 | 2 |
| 108 | Pool Shell | Apr. 11, 2002 | Apr. 16, 2002 | 6 |
| 108 | Aluminum Soffits | Apr. 15, 2002 | Apr. 16, 2002 | 2 |
| 108 | Window Sills | Apr. 17, 2002 | Apr. 17, 2002 | 1 |
| 108 | Construction | Apr. 17, 2002 | Apr. 17, 2002 | 1 |
| | Clean #2 | | | |
| 108 | Trim - Materials | Apr. 17, 2002 | Apr. 17, 2002 | 1 |
| 108 | Screen Enclosure | Apr. 17, 2002 | Apr. 17, 2002 | 1 |
| 108 | Trim - Installation | Apr. 18, 2002 | Apr. 18, 2002 | 1 |

TABLE 6
Variance Report
All SubDivisions
All trades
Start Date: Feb. 9, 2002
End Date: Mar. 9, 2002

| | | | | Scheduled | Actual | | |
|---|---|---|---|---|---|---|---|
| Trade | Lot# | Task | Description | Completion | Completion | Duration | Variance |
| D & S Tilers | RTV-102 | 232 | Ceramic-Bath | Mar. 8, 2002 | Mar. 9, 2002 | 2 | 1 |
| Dewitt Concrete | RTV-102 | 296 | Flatwork-Pour/Strip | Mar. 8, 2002 | Mar. 9, 2002 | 1 | 1 |
| DeWitt Concrete | LDG-252 | 142 | Slab Pour | Feb. 21, 2002 | Feb. 22, 2002 | 9 | 1 |
| Raphael Garcia | RTV-101 | 172 | Exterior Doors Set | Mar. 7, 2002 | Mar. 9, 2002 | 1 | 2 |
| Apollo marble | RTV-101 | 176 | Marble Tub | Mar. 7, 2002 | Mar. 9, 2002 | 1 | 2 |
| One Stop HVAC | RTV-102 | 240 | A/C Trim | Mar. 7, 2002 | Mar. 9, 2002 | 1 | 2 |
| Orange County | RTV-102 | 294 | Flatwork-Inspect | Mar. 7, 2002 | Mar. 9, 2002 | 1 | 2 |
| Building Dept | | | | | | | |
| Sonshine Drywall | RTV-101 | 170 | Interior Partitions | Mar. 6, 2002 | Mar. 9, 2002 | 3 | 3 |
| Spurlock Painting | RTV-102 | 230 | Paint-Interior | Mar. 5, 2002 | Mar. 9, 2002 | 2 | 4 |
| DeWitt Concrete | RTV-102 | 292 | Flatwork-Form | Mar. 4, 2002 | Mar. 9, 2002 | 1 | 5 |

TABLE 7
Payment Approval Report
All SubDivisions
All trades
Start Date: Feb. 28, 2002
End Date: Mar. 9, 2002

| | Vendor | | Lot | Activity | Task | Completion |
|---|---|---|---|---|---|---|
| Trade | ID | Subdivision | No | ID | Description | Date |
| Affordable Plumbing | a1204-103 | Raintree Village | RTV-103 | | Rough Plumbing | Mar. 1, 2002 |
| Affordable Plumbing | a1204-106 | Raintree Village | RTV-106 | | Rough Plumbing | Mar. 1, 2002 |
| Affordable Plumbing | a1204-120 | Raintree Village | RTV-120 | | Rough Plumbing | Mar. 1, 2002 |
| Apollo marble | a7856-103 | Raintree Village | RTV-103 | | Marble Tub | Mar. 1, 2002 |
| Apollo marble | a7856-106 | Raintree Village | RTV-106 | | Marble Tub | Mar. 1, 2002 |
| Apollo marble | a7856-120 | Raintree Village | RTV-120 | | Marble Tub | Mar. 1, 2002 |
| Apollo marble | a7856-101 | Raintree Village | RTV-101 | | Marble Tub | Mar. 9, 2002 |
| Collis Roofing | -111 | Raintree Village | RTV-111 | | Roof - Installation | Mar. 1, 2002 |
| D & E Elect | -103 | Raintree Village | RTV-103 | | Rough Electric | Mar. 1, 2002 |
| D & E Elect | -117 | Raintree Village | RTV-117 | | Rough Electric | Mar. 1, 2002 |
| D & E Elect | -155 | Raintree Village | RTV-155 | | Rough Electric | Mar. 1, 2002 |
| D & E Elect | -101 | Raintree Village | RTV-101 | | Rough Electric | Mar. 9, 2002 |
| D & E Elect | -102 | Raintree Village | RTV-102 | | Electrical Trim | Mar. 9, 2002 |
| D & S Tilers | -102 | Raintree Village | RTV-102 | | Ceramic - Bath | Mar. 9, 2002 |
| DeWitt Concrete | -102 | Raintree Village | RTV-102 | | Flatwork - Form | Mar. 9, 2002 |
| DeWitt Concrete | -102 | Raintree Village | RTV-102 | | Flatwork - Pour/Strip | Mar. 9, 2002 |
| Jana Lucas | -101 | Raintree Village | RTV-101 | | Construction Clean#1 | Mar. 1, 2002 |
| Jana Lucas | -102 | Raintree Village | RTV-102 | | Construction Clean#2 | Mar. 1, 2002 |
| Jana Lucas | -122 | Raintree Village | RTV-122 | | Construction Clean#1 | Mar. 1, 2002 |
| Lucas Const | -102 | Raintree Village | RTV-102 | | Trim - Installation | Mar. 1, 2002 |
| One Stop HVAC | -103 | Raintree Village | RTV-103 | | Rough A/C | Mar. 1, 2002 |
| One Stop HVAC | -106 | Raintree Village | RTV-106 | | Rough A/C | Mar. 1, 2002 |
| One Stop HVAC | -117 | Raintree Village | RTV-117 | | Rough A/C | Mar. 1, 2002 |
| One Stop HVAC | -101 | Raintree Village | RTV-101 | | Rough A/C | Mar. 9, 2002 |
| One Stop HVAC | -102 | Raintree Village | RTV-102 | | A/C Trim | Mar. 9, 2002 |
| Orlando Munl | 458-789-120 | Raintree Village | RTV-120 | | Water Services | Mar. 1, 2002 |
| Company | | | | | | |
| Orlando Munl | 458-789-122 | Raintree Village | RTV-122 | | Water Services | Mar. 1, 2002 |
| Company | | | | | | |
| Raphael Garcia | -103 | Raintree Village | RTV-103 | | Exterior Doors Set | Mar. 1, 2002 |
| Raphael Garcia | -120 | Raintree Village | RTV-120 | | Exterior Doors Set | Mar. 1, 2002 |
| Raphael Garcia | -101 | Raintree Village | RTV-101 | | Exterior Doors Set | Mar. 9, 2002 |
| RCS | -101 | Raintree Village | RTV-101 | | Preface Fireplace | Mar. 1, 2002 |
| RCS | -103 | Raintree Village | RTV-103 | | Preface Fireplace | Mar. 1, 2002 |
| RCS | -120 | Raintree Village | RTV-120 | | Preface Fireplace | Mar. 1, 2002 |
| Sam Wilson Masonry | 345-456-101 | Raintree Village | RTV-101 | | Exterior Glass Blocks | Mar. 1, 2002 |
| Sam Wilson Masonry | 343-456-122 | Raintree Village | RTV-122 | | Exterior Glass Blocks | Mar. 1, 2002 |
| Sonshine Drywall | -120 | Raintree Village | RTV-120 | | Interior Partitions | Mar. 1, 2002 |
| Sonshine Drywall | -122 | Raintree Village | RTV-122 | | Interior Partitions | Mar. 1, 2002 |
| Sonshine Drywall | -41 | Country Lake | CNL-41 | | Interior Partitions | Mar. 4, 2002 |

shows a screen display for the “models” choice listed in the main menu screen display of Table 1, and Table 3 shows a screen display for the “templates” choice listed in the main menu screen display of Table 1. Tables 4-7 show by way of example several types of reports which may be generated through the system. Table 4 shows a typical screen display for a specific subdivision. Table 5 shows a screen display for the “lot status report.” Table 6 shows a screen display for a “variance report”, and Table 7 shows a screen display for a “payment approval report” choice. As noted elsewhere herein, access to information and report generation may be restricted according to type of user.

The process of the invention may include various levels of access to the system, for example, wherein creating a construction schedule is restricted to a system administrator. Accessing the system for updating of an individual construction project, as shown in Tables 4-7, may be restricted to a field supervisor for the construction project's responsible builder. Further, a level of accessing the system may be restricted to a person selected from a system administrator, a field supervisor for a responsible builder, a trades contractor, and a combination thereof. The skilled will appreciate that accessing and updating most preferably comprise wireless communications, so that these activities are easily carried out from the field.

The process also includes generating various status reports, examples of which are shown in FIGS. 9-15, and which can be set up to occur at predetermined time intervals to thereby monitor periodic construction project progress. In addition to periodic status reports, generating may also occur on demand from a system administrator, a field supervisor for a responsible builder, a trades contractor, and a combination thereof. Furthermore, generating may additionally comprise communicating a daily status report by fax transmission, and particularly wherein the fax transmission is made over the computer network.

The system process provides the option of contacting a responsible trades contractor by wireless communication responsive to a status report indicating a scheduling delay. For example, when a field supervisor instructs the system to generate a status report, and the report indicates a schedule variance at a particular construction site, the field supervisor's field communication device will present the option of communicating with the field communication device for the trade contractor or other person responsible for the scheduling variance. By this process, the builder's field supervisor may inquire as to the cause and/or correction of the scheduling variance. It should be apparent that system generated status reports are accessible from or transmitted to field communication devices, so that current construction project scheduling information is always available in the field.

In operation of the system, a builders field supervisor may access scheduling information for a specified subdivision under construction. A display associated with the field communication device will show a list of active construction sites, or lots, within the selected subdivision. Upon selection of a desired lot, the display will show the schedule of upcoming tasks and events for the selected lot, for example, as shown in Table 5. The field supervisor may then select an individual task or event and may update the status of the particular task or event. The system will also offer the field supervisor the option of automatically contacting the trade contractor or other person responsible for the selected task or event, when the field communication device is a cellular phone a phone call will be the automatically initiated contact.

As a builder's field supervisor updates a particular task or event, the system will update the scheduling information in the database, which update will also become accessible through each trade's individual internet web page in the system. The skilled will appreciate the advantages of the system, wherein each trade contractor may access the system to display his or her own web site listing all scheduled tasks and events for the particular trade contractor.

As noted above, the system will provide various status reports, either on a predetermined time basis, or on demand by an authorized user. For example, a subdivision status report would include all field activity and projected construction schedules for sites within the subdivision. Within a subdivision status report display, an individual lot may be selected to obtain only the scheduling information pertinent to that specific lot construction site. Variance reports showing every scheduling delay may be generated as desired, for example, by trade across several subdivisions, by single subdivision, or by other desired parameters. For example, a variance report for all trades and all subdivisions is shown i Table 6. Billing status reports, as shown in Table 7, may also be generated to show payments due and/or made to the various trades and suppliers for completed tasks and events. Such billing reports may help reduce or eliminate the need for individual invoicing, and also reduce the time-consuming field approval process.

It will be appreciated that the present system also provides a measure of personnel supervision, particularly when implementing a preferred embodiment of the system including field communication devices having geographic positioning capabilities. For example, the movement of each field communication device may be tracked by the system, and tracking reports may be generated accordingly.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That which is claimed:

1. A system for scheduling a plurality of simultaneous construction projects, the system comprising:
at least one server computer connected to a computer network;
software capable of scheduling multiple events among a plurality of construction projects, said software controlling said at least one server computer; and
a plurality of field communication devices each device of said plurality having a display and being capable of wirelessly connecting through the computer network for interactively communicating with said at least one server computer through security controlled access thereto.

2. The system of claim 1, wherein said plurality of field communication devices comprises devices selected from cellular telephones, personal digital assistants, pagers, and combinations thereof.

3. The system of claim 1, wherein said plurality of field communication devices comprises at least one cellular telephone capable of communicating by radio transmission in addition to cellular telephone communication.

4. The system of claim 1, wherein the computer network comprises a global computer network.

5. The system of claim 1, further comprising at least one client computer interactively communicating with said at least one server computer.

6. The system of claim 1, further comprising at least one fax machine connected to receive a fax transmission from said at least one server computer.

7. The system of claim 1, wherein said fax transmission is effected through the computer network.

8. The system of claim 1, wherein the security controlled access comprises password protection.

9. A system for scheduling a plurality of simultaneous construction projects, the system comprising:
at least one server computer connected to a computer network;
software capable of scheduling multiple events among a plurality of construction projects, said software controlling said at least one server computer; and
a plurality of field communication devices each device of said plurality having a display and being capable of wirelessly connecting through the computer network for interactively communicating with said at least one server computer through a security controlled access including a unique identifier corresponding to each individual field communication device.

10. The system of claim 9, wherein said plurality of field communication devices comprises devices selected from cellular telephones, personal digital assistants, pagers, and combinations thereof.

11. The system of claim 9, wherein said plurality of field communication devices comprises at least one cellular telephone capable of communicating by radio transmission in addition to cellular telephone communication.

12. The system of claim 9, wherein the computer network comprises a global computer network.

13. The system of claim 9, further comprising at least one client computer interactively communicating with said at least one server computer.

14. The system of claim 9, further comprising at least one fax machine connected to receive a fax transmission from said at least one server computer.

15. The system of claim 9, wherein said fax transmission is effected through the computer network.

16. The system of claim 9, wherein the security controlled access comprises password protection.

17. A system for scheduling a plurality of simultaneous construction projects, the system comprising:
at least one server computer connected to a computer network;
software capable of scheduling multiple events among a plurality of construction projects, said software controlling said at least one server computer; and
a plurality of field communication devices each device of said plurality having a display, being capable of wirelessly connecting through the computer network for interactively communicating with said at least one server computer through security controlled access thereto, and including geographic positioning capability so as to communicate position to said at least one server computer.

18. The system of claim 17, wherein said plurality of field communication devices comprises devices selected from cellular telephones, personal digital assistants, pagers, and combinations thereof.

19. The system of claim 17, wherein said plurality of field communication devices comprises at least one cellular telephone capable of communicating by radio transmission in addition to cellular telephone communication.

20. The system of claim 17, wherein the computer network comprises a global computer network.

21. The system of claim 17, further comprising at least one client computer interactively communicating with said at least one server computer.

22. The system of claim 17, further comprising at least one fax machine connected to receive a fax transmission from said at least one server computer.

23. The system of claim 17, wherein said fax transmission is effected through the computer network.

24. The system of claim 17, wherein the security controlled access comprises password protection.

25. A process for scheduling a plurality of construction projects, the method comprising:
creating a plurality of construction schedules in a database stored in a server computer, each construction schedule of the plurality corresponding to an individual construction project;
accessing the database by security controlled communication through a computer network;
updating information for individual construction schedule records in the database;
generating a status report for a predetermined construction schedule by processing information in the database to thereby monitor progress of the corresponding construction project.

26. The process of claim 25, wherein creating is restricted to a system administrator.

27. The process of claim 25, wherein updating of an individual construction project is restricted to a field supervisor for a responsible builder.

28. The process of claim 25, wherein accessing is restricted to a person selected from a system administrator, a field supervisor for a responsible builder, a trades contractor, and a combination thereof.

29. The process of claim 25, wherein accessing comprises wireless communication.

30. The process of claim 25, wherein updating comprises wireless communication.

31. The process of claim 25, wherein generating occurs at predetermined time intervals to thereby monitor periodic construction project progress.

32. The process of claim 25, wherein generating occurs on demand from a system administrator, a field supervisor for a responsible builder, a trades contractor, and a combination thereof.

33. The process of claim 25, wherein generating further comprises communicating a daily status report by fax transmission.

34. The process of claim 25, wherein generating further comprises the option of contacting a responsible trades contractor by wireless communication responsive to a status report indicating a scheduling delay.

35. The process of claim 25, further comprising communicating a generated status report to at least one field communication device.
